(19) United States
(12) Patent Application Publication
(10) Pub. No.: US 2007/0264956 A1
(43) Pub. Date: Nov. 15, 2007

(54) System Events and Messages in a Computing System

(76) Inventors: Sandra Bicker, Heidelberg (DE); Iris Nieder, Walldorf (DE); Annett Hardt, Mannheim (DE); Ingo Deck, Mannheim (DE); Erik Oster, Heidelberg (DE); Till Brinkmann, Mannheim (DE); Boris Bierbaum, Frankfort (DE); Martin Dauer, Alsting (FR); Theo Held, Wiesloch (DE); Martin Schrepp, Hockenheim (DE)

Correspondence Address: FISH & RICHARDSON, P.C., PO BOX 1022, MINNEAPOLIS, MN, 55440-1022, US

(21) Appl. No.: 11/618,505

(22) Filed: Dec. 29, 2006

Related U.S. Application Data
(60) Provisional application No. 60/800,055, filed on May 12, 2006.

(51) Int. Cl. H04B 1/18

(52) U.S. Cl. 455/186.1

(57) ABSTRACT

In an enterprise resource computing system, an indication that an event has occurred may be received, where the event is associated with an application of the enterprise resource computing system. After receiving the indication, one of several priority classifications may be assigned to the event. Each of the priority classifications may correspond to a distinct level of significance to a user. A system message that includes an indicator of the priority classification may be generated, and one of a plurality of message display areas in a graphical user interface of the enterprise resource computing system may be selected for displaying the system message. Each of the message display areas may have a predefined location in the graphical user interface; the selection of the message display area may be based on the priority classification; and the system message may be displayed in the selected message display area.

### CROSS-REFERENCE TO RELATED APPLICATION

This application claims priority from U.S. Provisional application No. 60/800,055, filed May 12, 2006, and entitled “UI Concept,” the entire contents of which are incorporated herein by reference.

### TECHNICAL FIELD

This document relates to processing system events and presenting system messages in a computing system.

### BACKGROUND

Computer system users interact with computer systems in a variety of ways. A user of a software application running on a computer system may provide input to the computer system using a variety of input devices, and may be presented with output or feedback from the system in response to a variety of events, conditions, or circumstances. As computer systems and the applications that run on them grow in complexity and utility, and as users continue to integrate computer systems into their daily activities, effective information conveyance from the computer system to the computer system user becomes essential.

One popular method of apprising the user of information involves display of a message on a display screen of the computer system. Such a message may inform the user that something has occurred in the application that requires attention, that an event has occurred, that a problem was encountered within the application, or that the application has performed a task. One example of such a message presentation system causes a popup window to appear on the display screen when a message is presented. The popup window contains a message with text that describes the reason for the message's presentation, and appears over the application view on the display screen, obscuring a portion of the application view on the display screen. In conjunction with the message presentation within the popup window, user interaction with the application is suspended pending acknowledgement of the message. The popup window includes a control, such as a close button, that the user must select to acknowledge the message and restore interactive capability with the application. The popup window thereafter is removed from the display screen, application interactive capability is restored, and the user may continue to use the application. However, users may become annoyed by the disruptive nature of this messaging system, as they may be repeatedly interrupted by messages, some of which may be of interest to the user, but others of which may not be of interest to the user. Additionally, users may occasionally desire to see feedback concerning events occurring within the computer system that did not cause a popup window message to be presented.

Another message technique involves storing messages chronologically in a message log, which a user may access to view the messages. Under this system, a user may have difficulty locating a message of interest, as the message may be interspersed among many different messages, some of which may be of interest to the user and others of which may not be of interest to the user. Additionally, the user may desire more immediate notification messages, and may prefer to have the messages presented in real time as the events that trigger the messages occur.

### SUMMARY

This document relates to processing system events and presenting system messages in a computing system.

In a first general aspect, a method includes receiving an indication that an event has occurred in an enterprise resource computing system, where the event is associated with an application of an enterprise resource computing system. After receiving the indication, one of several priority classifications is assigned to the event, where each of the priority classifications corresponds to a distinct level of significance to a user of the enterprise resource computing system. A system message that includes an indicator of the priority classification is generated to inform the user of the event, and one of a plurality of message display areas in a graphical user interface of the enterprise resource computing system is selected for displaying the system message. Each of the message display areas has a predefined location in the graphical user interface, and the selection of the message display area is based on the priority classification. The system message is displayed in the selected message display area.

In selected embodiments, the selected message display area is capable of displaying a plurality of messages, and a plurality of messages may be displayed in the selected message display area according to priority classification. A plurality of message display areas may be concurrently displayed on the display device of the enterprise resource computing system, and each of the plurality of displayed message areas may include a displayed message having a different priority classification. A message having a lower priority may be displayed in a less prominent position in the selected message display area than a message having a higher priority, even though the event associated with the lower priority message occurred later in time than the event associated with the higher priority message. The selected message display area may be dynamically resized when a new message is displayed. The message display area may include a scrollbar that can be navigated by the user to display additional messages.

In selected embodiments, a separate work area associated with the application of the enterprise resource computing system may be displayed on the display of the enterprise resource computing system, and the event may occur because of an action associated with the separate work area. The event may be associated with an application of the enterprise resource computing system that does not have any work areas displayed on the display of the enterprise resource computing system.

In selected embodiments, a modal window that includes information relating to the system message may be displayed. User input associated with the modal window may be received, and an event that can be used by an application to start an action may be triggered. The modal window may include a hyperlink, and the user input may be a selection of the hyperlink. In response to the selection of the hyperlink, a field having focus established thereon and capable of receiving user input may be displayed.

In a second general aspect, a graphical user interface for presenting system messages comprises a plurality of message display areas having a predefined location in the graphical user interface. System messages can be displayed in the message display areas, and each system message may be associated with a system event having a determined priority classification. Each of the system messages may include an indicator of the priority classification of the associated event, and display of each of the system messages in one of the plurality of message display areas may be dependent upon the associated priority classification.

Advantages of the systems and techniques described herein may include any or all of the following: Providing more user-friendly display of system messages; providing a more efficient display of system messages; providing a less distracting display of system messages; providing a better visual presentation of system messages; providing more consistency in message presentation; improving display of system messages; improving handling of system events; and providing a more-user-friendly GUI.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an exemplary architecture that can be used to handle events and generate and present system messages in an enterprise resource computing system.

FIGS. 2-4 are screen shots of exemplary user interfaces with multiple message display areas that can be used for displaying system messages in the computing system of FIG. 1.

FIG. 5 is a screen shot of a modal dialog box that may be displayed when a message is received in the computing system of FIG. 1.

FIG. 6 is a screen shot of a user interface following user selection of an option or link in the modal dialog box of FIG. 5.

FIG. 7 is a flow chart of exemplary operations that can be performed to display a system message in a selected message display area.

FIG. 8 is a block diagram of a computing system that can be used in connection with computer-implemented methods described in this document.

Like reference symbols in the various drawings indicate like elements.

### DETAILED DESCRIPTION

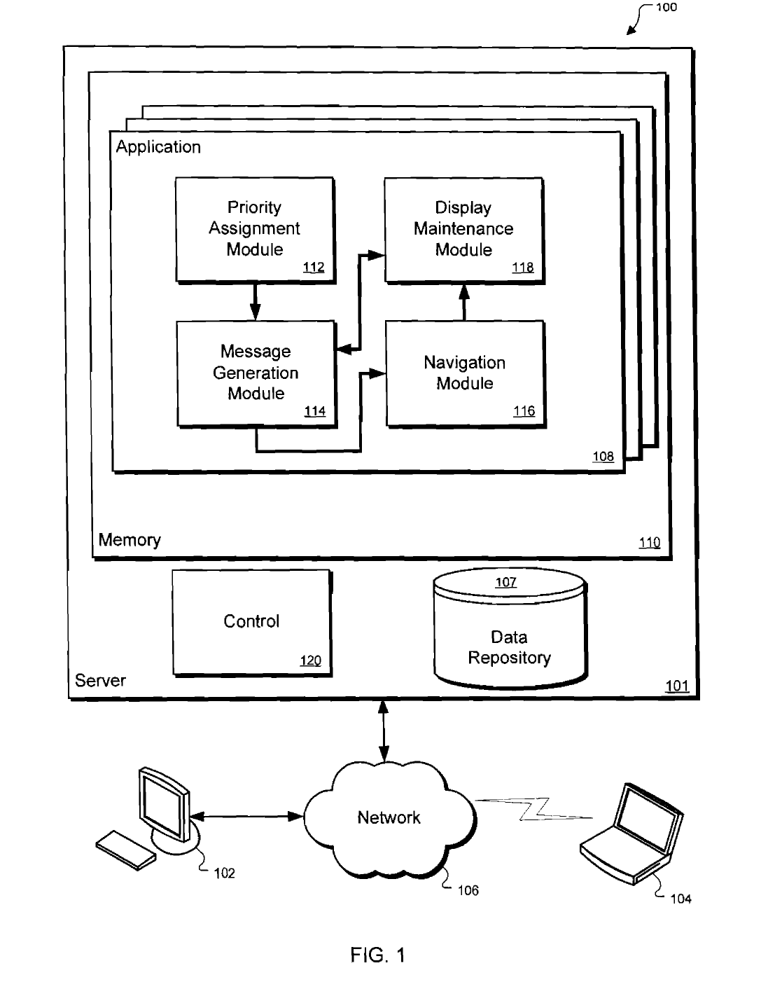

FIG. 1 is a block diagram of an exemplary architecture 100 that can be used in an enterprise resource computing system to handle events and generate and present system messages. For example, the architecture 100 may generate system messages in a server device 101 for presentation in one or more client devices 102 or 104 communicably connected to the server device 101 over a network 106. In general, events may occur in the enterprise resource computing system when a user or an external system modifies one or more fields associated with objects stored in the system, such as contracts, customer data, quantities, dates, names, and materials, to name a few examples. The architecture 100 may also centrally manage event data for various clients in the enterprise resource computing system. For example, events pertaining to multiple modules within the computing system may be simultaneously presented in several client devices as necessary, or alternatively may be stored in a data repository, such as data repository 107. Thus, advantageously, users of each client device 102, 104 may receive or retrieve important information regarding system events and may react in a timely manner. An enterprise resource computing system refers to one or more software applications or software components used to execute a plurality of business processes in an organization (e.g., businesses, non-profit organizations, non-governmental organizations and governments). As one skilled in the art will appreciate, typical enterprise resource computing systems include functions for performing at least one of enterprise resource planning (ERP), customer relationship management (CRM), supply chain management (SCM), human capital management (HCM), and supplier relationship management (SRM) processes.

The architecture 100 includes at least one application 108, such as an enterprise resource software application, that is generically shown residing in memory 110. As is conventional, the application 108 may be stored in a nonvolatile storage location, such as repository 107 or another repository, including a data store exterior to the server 101, and may be transferred to memory 110 for active use by the architecture 100. The application 108 includes several modules capable of prioritizing, transferring, and displaying event occurrences in the system. The modules include: a priority assignment module 112, a message generation module 114, a navigation module 116, and a display maintenance module 118.

The architecture 100 may use the priority assignment module 112 to classify and prioritize events as they occur. An event may be classified based on how important the event is, how important it is that a user be notified of the event, whether the user is required to respond in some way to the event, or a combination of the above. For example, the priority assignment module 112 may determine whether an event has low, medium or high priority, as well as determine if the event is simply informational. Any number of priority classifications are possible. The priority of the event may determine how the event information is displayed a user. For example, if a particular event has high priority, the user may wish to see a more prominent display indication such that immediate focus can be made to the high priority event. Conversely, if a particular event has low priority, the user may prefer notification of this event in a less prominent fashion.

Once the priority of a system event is determined, the message generation module 114 may create a system message from the event data. The message may be the only indication presented to the user that an event has occurred in the system. Examples of system messages may include: a low priority message, such as an information message; an extremely high priority message, such as an alert message; and messages having priority levels between the low priority and extremely high priority messages, such as a warning message or an error message. Error messages may generally have a higher priority than warning messages, and may be displayed in a separate message display area, or alternatively may be displayed in the same message display area in a more prominent fashion, such as at a more prominent location within the message display area. Messages may have identifying features that may enable users to distinguish between them. For example, a color or associated symbol (e.g., an icon) of a message can indicate its priority relative to another message. As another example, the order in which a message is presented in the system relative to other presented messages may indicate a hierarchy of priority levels.

The generated system messages may be presented in any of two or more message display areas on a display screen of the client devices (102 or 104), as will be explained more fully below. In one implementation, the system (e.g., the display maintenance module 118) may select an appropriate message display area based on the priority of the event associated with the message. The display maintenance module 118 may also determine whether or not to store received messages in the data repository 107, for example. In addition, the display maintenance module 118 may format system messages for display in one or more message areas in the client device 102 or 104. The display maintenance module 118 may also determine how messages are discarded from the system. For example, when a new message is received in the system, the display maintenance module 118 may store the old message and place the new message in a message list. The display maintenance module 118 may also increment or decrement a message counter as messages are received and expunged from the system. Messages may include hyperlinks that may direct the user to further information about the displayed system message, or about the event associated with the message. The navigation module 116 may determine the destination of the hyperlinks for each message.

Turning to the illustrated implementation, the architecture 100 includes or is communicably coupled with the server 101, the one or more client systems 102 and 104, and control devices 120, at least some of which can communicate across network 106. The server 101 generally hosts application software capable of generating and managing system messages in response to events that occur in the system. The server 101 comprises an electronic computing device operable to receive, transmit, process and store data associated with the architecture 100. Although FIG. 1 illustrates a single server 101 that may be used with the disclosure, the architecture 100 may be implemented using one or more computers other than servers, as well as a server pool. The server 101 may be any computer or processing device, such as, for example, a blade server, general-purpose personal computer (PC), Macintosh, workstation, Unix-based computer, or any other suitable device. According to one implementation, the server 101 may also include or be communicably coupled with a web server and/or a mail server.

The server 101 may include local electronic storage capacity, such as data repository 107. The data repository 107 may include any memory or database module and may take the form of volatile or non-volatile memory including, without limitation, magnetic media, optical media, random access memory (RAM), read-only memory (ROM), removable media, or any other suitable local or remote memory component. The illustrated data repository 107 may store system data such as message data, virtual private network (VPN) applications or services, firewall policies, a security or access log, print or other reporting files, HTML files or templates, data classes or object interfaces, unillustrated software applications or sub-systems, and others.

The server 101 also includes control devices 120. The control devices 120 may include one or more processors to execute instructions and manipulate data for performing the operations of the server 101. The control devices 120 may include, for example, a central processing unit (CPU), a blade, an application specific integrated circuit (ASIC), or a field-programmable gate array (FPGA), or other suitable hardware or software control system. In the illustrated implementation, the control devices 120 execute instructions that comprise the application 108.

The network 106 facilitates wireless or wireline communication between the server 101 and any other local or remote computers, such as clients 102 and 104. The network 106 may be all or a portion of an enterprise or secured network. In another example, the network 106 may be a virtual private network (VPN) between the server 101 and the client 102 across a wireline or a wireless link. While illustrated as a single or continuous network, the network 106 may be logically divided into various sub-nets or virtual networks without departing from the scope of this disclosure, so long as at least a portion of the network 106 may facilitate communications between the server 101 and at least one client (e.g., client 102). In certain implementations, the network 106 may be a secure network associated with the enterprise and certain local or remote clients 102 or 104. The network 106 may be the Internet.

The client 102 may be any computing device operable to connect or communicate with the server 101 or the network 106 using any communication link. At a high level, each client 102 may include or execute at least one hosted application graphical user interface. There may be any number of clients 102 communicably coupled to the server 101. As used in this disclosure, the client 102 is intended to encompass a personal computer, touch screen terminal, workstation, network computer, kiosk, wireless data port, smart phone, personal data assistant (PDA), one or more processors within these or other devices, or any other suitable processing device. For example, the client 102 may be a PDA operable to wirelessly connect with an external or unsecured network.

Regardless of the particular hardware or software architecture used, the application 108 may be generally capable of analyzing system events and generating and presenting system messages to multiple users from one or more entities, for example. Users of the application 108 may include sales personnel, customer service personnel, field applications personnel, repair or installation personnel, or any other user of business information. The following exemplary descriptions of screen shots focus on the operation of the application 108, or one of its components or sub-modules, in performing one of the respective methods or processes. However, the architecture 100 contemplates using any appropriate combination and arrangement of logical elements implementing some or all of the described functionality.

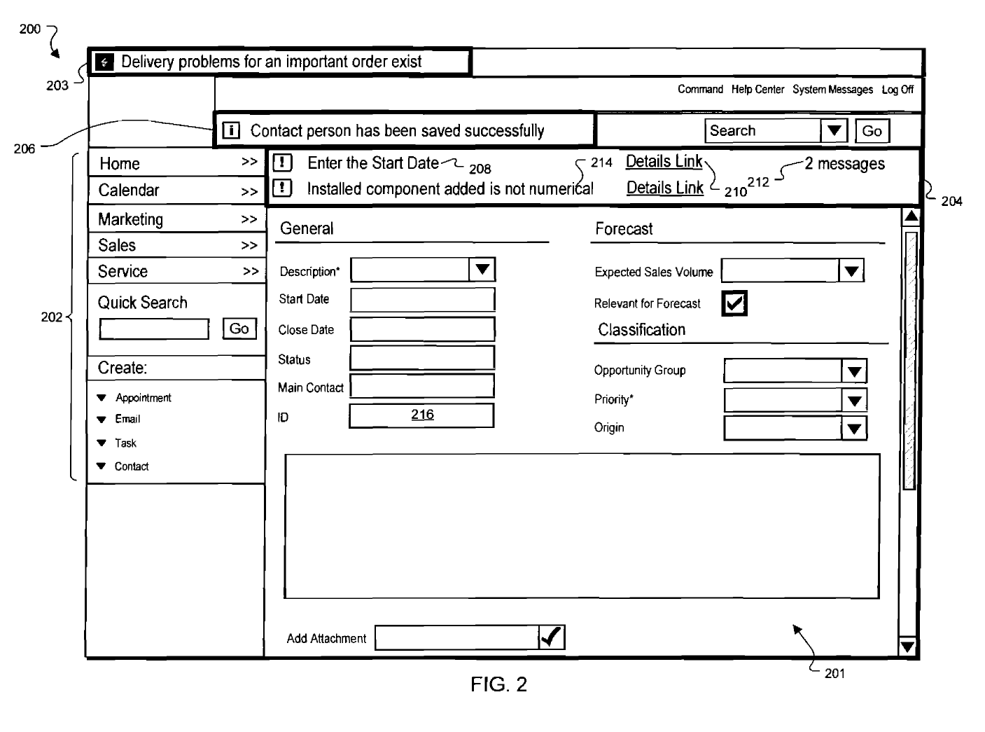

FIG. 2 is screen shot of an exemplary user interface 200 with multiple message display areas that can be used for displaying system messages in the computing system of FIG. 1. The user interface 200 includes a work area 201 for displaying screens that a user selects, a sidebar menu 202 for navigating the software architecture, and at least one message display area 203, 204, 206. As described above, more than one message area may be provided for displaying system messages. FIG. 2 is exemplary, and any number of multiple message display areas may be presented, (for example, two, three, four, five, or more) and these display areas may be located at any appropriate place within the user interface. In this example, FIG. 2 includes three distinct message areas 203, 204, 206, some or all of which can be designated for one or more particular message type. This may provide advantages by allowing a user of the system to concentrate attention on one or more of the message display areas, and devote less attention to other system messages. As such, sorting messages for presentation in any of several message display areas may permit a user to focus attention on higher priority messages, which may be presented in a particular message display area, while still permitting the user to view and react to all system messages, including messages having a lower priority, which may be presented in one or more of the other message display areas.

For example, some messages, such as an extremely high priority message, may require immediate user attention and further may require user action. Examples of extremely high priority messages may include messages related to insufficient system resources, or to equipment damage in a production plant that generally require immediate attention and/or repair. Further, extremely high priority messages can notify users of an unexpected decline or increase in resources, such as a drastic decline in revenue within a predefined time period. Conversely, some messages may simply inform a user that a routine event has occurred as expected. In this case, the user may still desire to view the confirmation message at some point, but may devote little or no attention to the message at the moment, thereby avoiding distraction from more important issues.

As shown in FIG. 2, the exemplary user interface 200 includes three areas 203, 204 and 206 that can display system information in message format. The user interface 200 may receive system messages having varying levels of priority from the message generation module 114 (FIG. 1). For example, a message may be prioritized as an alert message, indicating an extremely high priority, as an error message, indicating a high priority, as a warning message, indicating a medium priority, or as an information message, indicating a low priority. In other implementations, more or fewer priority levels may be used. Depending on the priority of the message, the display maintenance module 118 may select one of the display areas 203, 204, 206 for presentation of the message, according to one implementation.

As such, the user interface 200 includes the strategically placed areas 203, 204 and 206 to display the different types of messages in an aesthetic and functional manner. In general, users may find it advantageous to have messages consistently presented in a particular message display area at a particular location on the user interface based on message priority. For example, the first message area 203 may display the highest priority messages (e.g., alert messages) and may therefore be presented near the top of the application where a user can clearly distinguish the highest priority messages from other content in the user interface 200. In one implementation, alert messages include an alert icon that may or may not be color coded. In other implementations, a modal dialog box is presented when an alert message is received in the system, as will be explained more fully below.

The user interface 200 includes a second message area 204 that is illustrated as a message container, which can display messages having more than one priority level. For example, the message container 204 may display both error (e.g., high priority) and warning (e.g., medium priority) messages. Error and warning messages may be displayed in the message container 204 and may permit the user to quickly find and fix or modify necessary information in the system. Messages presented in the message container 204 may or may not include a navigation link or other data related to the message. For example, the message container 204 shown in FIG. 2 currently includes two warning messages, one of which indicates that the user should enter the “Start Date” (208). The warning 208 includes a navigation link 210, labeled “Details Link,” that the user may select to receive additional information concerning the warning. The link 210 may include further instructions pertaining to the warning message 208. In some implementations, a message can include two or more navigation links. For example, the text of the warning 208 may also include a link (not shown in FIG. 2) that, when selected, causes the system to present a view that includes a relevant field having a cursor focused on the field such that data may be entered to fix the warning. Navigation link destinations may be determined by the navigation module 116 (FIG. 1). The message container 204 also includes a message counter 212 that indicates how many messages currently reside in the message container 204. As shown by the counter 212 in FIG. 2, the message container 204 currently contains two messages, each of which are visible in the user interface 200.

Error messages and warning messages, like different types of system messages in general, may be provided with distinctive characteristics. For example, icons for the respective messages may be similar in shape, but different in color. In one implementation, error messages may include an error icon that is red and warning messages may include a warning icon that is yellow. Some implementations do not include icons with the system messages. Also, if icons are used, they may take any suitable shape. Both an error message and a warning message may indicate that a user should fix or modify a field in the application. For example, the error may generally indicate that user action is required before proceeding to another section of the application (e.g., before any data can be permanently saved), while the warning may not require user action before proceeding, but may indicate that an error may occur if no action is taken by the user.

The user interface 200 includes a third message area 206 for displaying low priority information messages about nonvolatile system events. As an example, when a contract or contact data is saved, an information message may be generated to indicate that the task has been completed successfully. User interaction may not be necessary for information messages as they are generally used to verify an action or task completion. As shown, the information message in message area 206 indicates that a contact person has been saved successfully. In one implementation, information messages may include a unique icon shape and a green color.

In an implementation, the display of messages in one message display area does not affect other message display areas. For example, when a new error message is received and displayed in the message container display area 204, the alert message area 203 and the information message area 206 may not be modified. Similarly, alert messages can be received and displayed without interfering with the message container 204 or the information message area 206. The following examples relate to the user interface 200 receiving and handling different messages from the application 108.

As shown in FIG. 2, the alert message area 203 currently displays an alert message showing the phrase “Delivery problems for an important order exist.” The alert message is of the highest priority, and indicates that the user may have an action to perform related to a previously entered order. For example, another user in the system may have modified the delivery date for an order, thereby prompting a modification to be made elsewhere. Here, the user may notice the alert message, and may take action to resolve the event conflict that may have caused the alert. In some implementations, the user may be graphically prompted to take action immediately. For example, a modal dialog box having selectable options may appear over the user interface 200.

Medium and high priority messages may be received and displayed, in succession or concurrently, in the same or in a different message display area. In FIG. 2, medium priority messages are shown in the message container 204 with message titles describing the message and icons indicating that the messages are warnings. Specifically, one warning message 214 indicates that an installed component added is not a numerical value. This warning message 214 may occur when a user enters a non-numerical value for an ID field 216, for example. Here, the system may not accept the value based on rules implemented for ID field 216; specifically, the ID field 216 may require a numerical value. Thus, any non-numerical value may trigger display of the warning message 214 in the message container 204. The warning message 214 is classified as a warning because the system may simply evaluate data before a save operation is performed, for example. In some implementations, upon performing a save action, some warning messages may trigger error messages related to the warning messages. As such, the warning message may be ignored until the form is completed, for example. However, if the user proceeds with the save operation, the warning messages may trigger similar error messages and require the user to resolve the errors before proceeding.

Low priority or informational messages can also be received in succession, or concurrently, with medium and high priority messages. As shown, the information message area 206 currently includes an information message indicating that the contact person has been saved successfully. As described above, the information message area 206 may be a relatively non-invasive information area that provides feedback to the user upon completion of system tasks. The following screen shot displays another example of how messages may be shown in the message container.

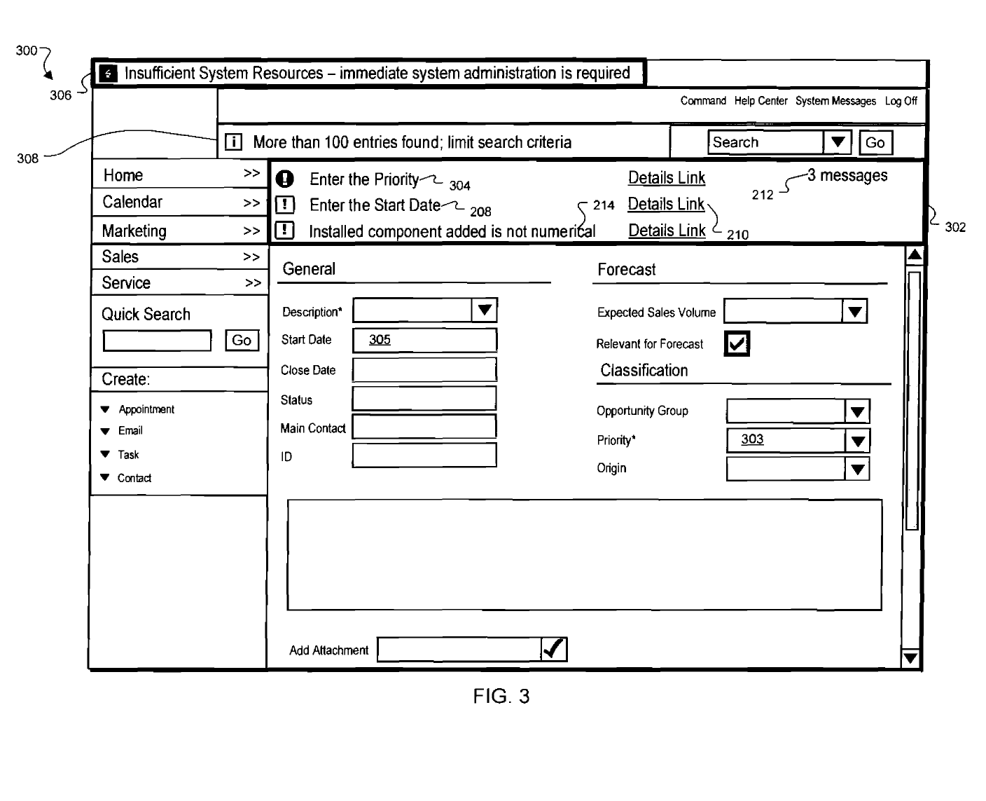

FIG. 3 is another screen shot of an exemplary user interface 300 with multiple message display areas for displaying system messages in the computing system of FIG. 1. FIG. 3 includes a message container 302 that illustrates how a new high priority message may be received and displayed. In general, messages in container 302 may be prioritized and displayed in various ways. In one implementation, the new messages may be prioritized in a chronological, descending order according to the particular assigned priority level and displayed as such in the message container 302. For example, when a new message is received, the message display area 302 may display the message at the top of the message queue and shift existing messages down within the area. In another implementation, the messages may be classified in a more urgent (high priority) or less urgent (low priority) category according to priority codes that may be assigned by the system. For example, when a high priority message (e.g., error message) is received, the error message may be displayed at the top of the message queue and may remain there until another error message is received, when the new error message may be categorized with the same priority, but with a newer timestamp, and may replace the previous error message at the top of the queue, shifting the earlier message down. In this example, lower priority messages (e.g., warning messages) that are received by the system 100 may be displayed below higher priority messages, even if the lower priority messages were received more recently. Advantageously, this classification method may allow users to easily view the higher priority error messages and react accordingly since they are displayed at or near the top of the message queue within the container 302.

In one implementation, a higher priority message may indicate that the system requires some form of user action to proceed, while a lower priority message may indicate that user action is not required for continued processing. Referring again to FIG. 3, the system may require that a priority 303 be entered, and may indicate the same with an error message 304 at the top of the message container 302. In contrast, the system may not require that a start date 305 be entered. However, a user may still like to know that a start date may be entered or should be entered, and a warning message 208 may be provided to alert the user to this information. Thus, in this example, an event triggering the “start date” warning message 208 may occur after the event that triggered the “priority” error message 304, yet the lower-priority warning message 208 may be displayed below the higher-priority error message. Similarly, the messages 304, 208 may be presented as shown in FIG. 3 even if the warning message enters the message container at a later time than any error messages. In other implementations, either type (e.g., warning message or error message) may require some form of user action. Alternatively, either type of message may not require any user action for the user to proceed with other tasks in the user interface 300.

In some implementations, the user of the user interface 300 may customize the message container display 302 to view messages in another order or location in the interface. For example, the user may select controls (not shown) to sort the received messages in a particular order (e.g., by date, time, importance, required action, or software module affected, etc.). In addition, the user may choose to view more or fewer messages in the message container at one time. In some implementations, the message areas may not be shown prior to an occurrence of a first event for which a message is generated. In other implementations, the message areas may appear, but may display no information prior to an occurrence of a first event.

The message container 302 is exemplary and may generally show one to three rows of message data, but as mentioned above can be user configurable. In the default example, the message container may display one, two, or three rows of data depending on how many messages are available for viewing. For example, if one message is available to view, one row may be shown in the message container 302. Similarly, when two or three messages are available to view, two and three rows may be shown, respectively, in the message container 302. Here, the message container 302 may be dynamically resized as more messages become available for viewing. For example, referring to FIGS. 2-3, the message container 204 in FIG. 2, which contains two messages 208, 214, is shown dynamically resized as message container 302 in FIG. 3 after receiving new message 304, for a total of three messages 304, 208, 214, and occupies a comparatively larger portion of the user interface 300. Dynamic resizing of the message container 302 may advantageously provide an additional visual indication that a new message has been received in the container 302. For example, when comparing the message container 204 in FIG. 2 with the message container 302 in FIG. 3, it may be noticeable that the size of the message container has increased to display three messages, when two messages had previously been displayed (FIG. 2).

The message container 302 may also increment or decrement the message counter 212 as another indicator of a change in message count. As shown in FIG. 3, the message counter 212 currently indicates that “3 messages” are available for review. Further, navigation links to detailed information related to the messages are shown, but can be optional and in some implementations can be user configurable. In particular, the message container 302 shows the previous two warning messages 208, 214 (FIG. 2) and also shows the new error message 304.

The user interface 300 includes a new alert message, shown at 306, that indicates an insufficient amount of system resources, and further notes that immediate system administration is required. The alert message may have been generated in response to an event caused by the current user or any other user of the system modifying a system resource (e.g., memory, quantity of goods, or personnel staff, etc.) thereby exceeding a system limitation. In some implementations, the alert message need not be associated with what is presently displayed on the screen in a particular work area. For example, the alert message shown at 306 may be unrelated to anything displayed in the user interface 300. Alternatively, a user action within a presently displayed work area on the user interface 300 may trigger an alert message.

The user interface 300 also includes a new information message, shown at 308. The information message shows that more than one hundred entries have been found, and further instructs a user to limit the search criteria. The information message may have been generated in response to the user requesting a search task in an attempt to find system data, such as resources, customer information, status information, or any other system available data.

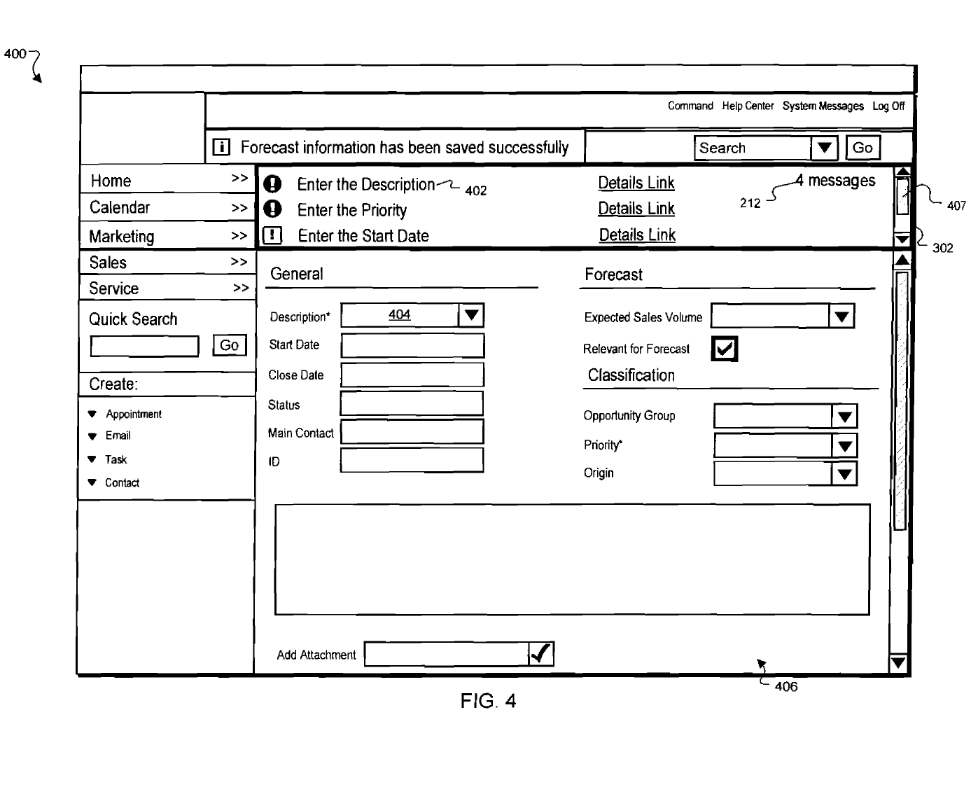

Thus, as seen in FIG. 3, the system may provide system messages that include notification of events having different levels of priority in a convenient and user-friendly fashion. For example, messages may include further instructions to assist users in resolving system issues. The instructions may also include a hyperlink to message data. The hyperlink may include a help aspect, such as a tool tip that can be activated by a mouse-over or link selection, for example. Other messaging features are available to guide users while using the computing system 100. FIG. 4 will describe a few examples of the messaging features.

FIG. 4 is yet another screen shot of an exemplary user interface 400 with multiple message display areas that can be used for displaying system messages in the computing system of FIG. 1. Here, a new error message 402 is received and, in this example, has been placed at the top of the message queue since the priority is categorized as high for error messages. The new error message 402 indicates that a description 404 is required in a currently-displayed field 404 in the current work area 406. In some implementations, the error message may not correspond to the current work area 406, but may instead correspond to another screen, module or interface. Upon receiving the new error message 402, the message counter 212 can be incremented. In this example, the message counter 212 has been incremented from “3 messages” (see FIG. 3) to “4 messages.” While the viewable area of the message container 302 remains at three visible lines, a scroll bar 407 is included to permit the user to navigate through additional messages outside of the current view. A user may use the scrollbar 407 to navigate within the message container and view the fourth message (not shown in FIG. 4), which in this example may be the warning message 214 shown in FIG. 3.

The message container 302, or any of the message display areas generally, may have various states. For example, a first exemplary state can be shown before a first event occurs where no messages are displayed in the message container 302, and in some implementations, the message container 302 may not be displayed until a first event has occurred. A second exemplary state is shown by FIG. 2 or FIG. 3 after events have occurred in the system. In this example, one to three lines of messages are displayed in the message container in the second state. A third exemplary state is shown by FIG. 4 after more than three events have occurred in the system. In this example, three lines and the scroll bar 407 are displayed in the message container, indicating that the message container 302 includes more than three messages. In general, the states may include the message counter 212 as an indication of how many message remain in the message container 302. In some implementations, messages can be removed from the message container 302 by resolution of the corresponding warning or error. In other implementations, system users may delete messages. However, if an error message requires further user action, the message may reoccur upon deletion, or in some implementations, may not be deleted until resolution occurs.

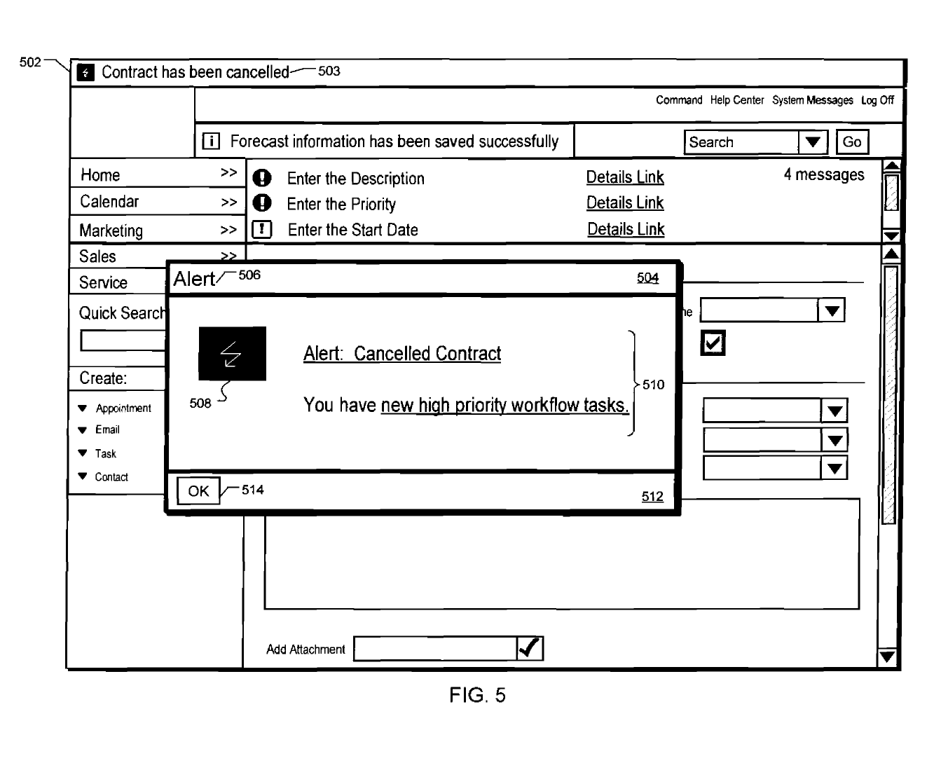

FIG. 5 is a screen shot of a modal dialog box that may be displayed when a message is received in the computing system of FIG. 1. In the example shown in FIG. 5, the modal dialog box corresponds to an alert message. As described above, alert messages are generally of highest priority and, as such, are displayed in a separate alert message area 502. The alert message 503 shown in FIG. 5 indicates that a contract has been cancelled somewhere in the system. Here, the alert message also triggers display of a modal dialog box 504. The modal dialog box includes a title bar 506, an icon 508, message data and links 510, and a control bar 512. The title bar 506 and icon 508 may indicate that the modal dialog box 504 is related to an alert message. The message data 510 may display a reason for the alert message and a link to a screen that can resolve the event conflict. Alternatively, the modal dialog box may not display a link, and may simply provide further information about the alert message. In other implementations, no further information is shown in the modal dialog box, as the appearance of the modal box itself may convey the desired information.

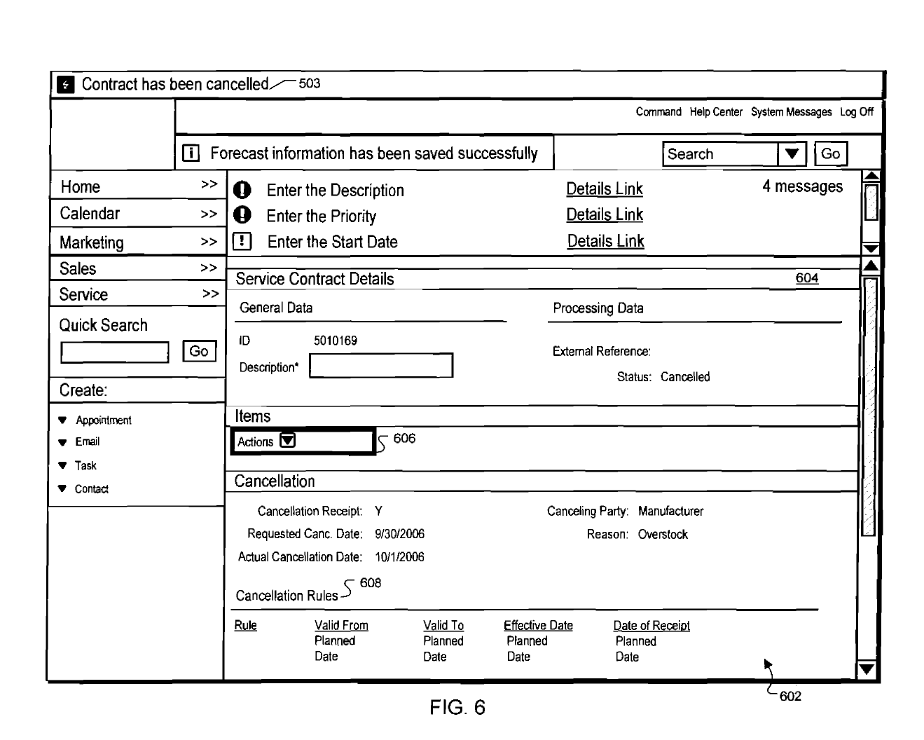

Upon presentation of a modal dialog box, such as the dialog box 504, the user may select various options. In one implementation, the user may select a control on the control bar 512, such as an OK button 514, to acknowledge the modal dialog box 504 and possibly resolve the event conflict at a later time, or to take another action. Other control buttons may be included on the control bar 512, such as an ignore button, cancel button, snooze button, or a save button, to name a few examples. The user may also select the displayed link to immediately jump to a screen that may resolve the event conflict. In one implementation, following a selection of the navigation link, the system may present a screen that includes a field that may be modified in a way that resolves the event that caused the message. Additionally, the screen may be presented such that focus is established in the field, which may permit a user to immediately modify the field, as will be described in more detail below with respect to FIG. 6. Thus, a user may be directed to the precise field that triggered the event that caused the message, and may quickly and easily correct any corresponding issue. In general, alerts may include modal dialog boxes to give the user further visual advantages for resolving an alert in a short amount of time. However, alerts need not include the modal dialog box to be classified as an alert. In some implementations, users can choose to suppress all modal dialog boxes as to not receive interruptions during a software session.

FIG. 6 is a screen shot of a user interface following user selection of an option or link in the modal dialog box of FIG. 5. Here, the user has selected a hyperlink in the modal dialog box 504, causing the system to display a work area 602 that includes an associated or relevant screen. Since the alert message 503 indicates that a contract has been cancelled, the system may automatically navigate the user to a service contract details screen 604 following selection of the related link, where the user may repair content or update contract information accordingly. As shown in FIG. 6, the cursor has been automatically focused on a user action control 606, where the user can select from available actions to resolve the event conflict. In some implementations, the focus may be placed directly over a field that caused the event that triggered the message. For example, the cursor may be placed on a “cancellation rules” section 608 to alert the user to a rule that may have been broken and caused the cancellation. This may provide an intuitive and convenient way for a user to resolve the cancelled contract or to take action to minimize losses resulting from the cancelled contract. For example, the alert may remind the user to cancel orders for parts or other related services when a contract has been cancelled.

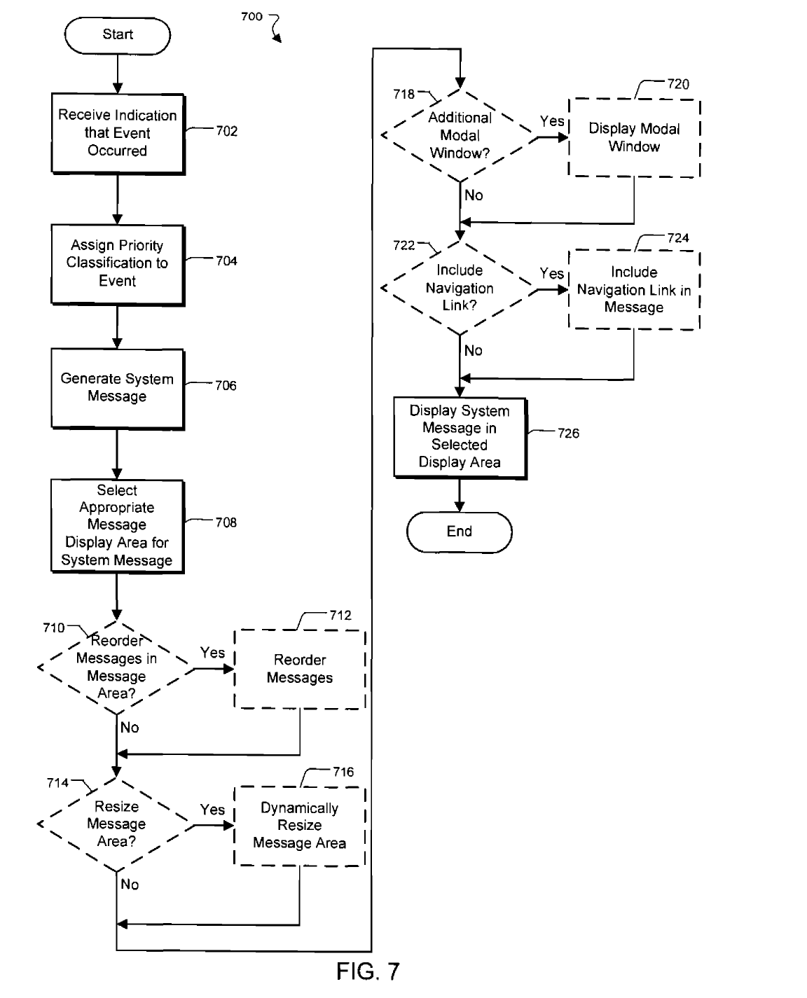

FIG. 7 is a flow chart of exemplary operations 700 that can be performed to display a system message in a selected message display area. The operations 700 can be performed by a processor executing instructions stored in a computer program product. The operations 700 begin in step 702 with receiving an indication that an event has occurred in the enterprise resource computing system. For example, the system shown in FIG. 1 may receive the event and may further associate the event with a particular application. In step 704, the operations comprise assigning one of several priority classifications to the received event, each corresponding to a distinct level of significance to a user of the enterprise resource computing system. For example, the priority assignment module 112 (FIG. 1) may assign a low, medium, high, or extremely high priority to the received event. Next, in step 706, a system message can be generated to inform the user of the event whereby the priority classification is retained. For example, the message generation module 114 (FIG. 1) may generate a specific type of message based on the priority classification of the event. The messages can include text, icons, or color to indicate the type of message to the user.

Upon assigning a priority to the message, the operations 700 can comprise selecting one of a plurality of message display areas in a graphical user interface to display the message to the user, in step 708. For example, the display maintenance module 118 (FIG. 1) may determine where to display each received message depending on the priority classification. The user interface 200 (FIG. 2) shows an example of three distinct message display areas 203, 204, and 206 for displaying messages having different priority classifications. For example, extremely high priority messages may be displayed in area 203, high and medium priority messages may be displayed in area 204 and low priority messages may be displayed in area 206.

The operations 700 can comprise determining several display options for the message display areas. The display options can be selected successively or concurrently, and selecting one option may not affect the other configured display options. As such, each step between 710 and 724 is optional and may be omitted. In step 710, the operations can optionally comprise determining whether or not to reorder messages in a specific message area. For example, the display maintenance module 118 (FIG. 1) may determine a message order in the message display area 204. If the operations 700 comprise determining to reorder the messages, the messages may be reordered accordingly, in step 712. This may occur, for example, if a given message area is being used to display two or more types of messages having different priority levels. In one implementation, the messages having lower priority may be displayed below messages having higher priority, even if the message having lower priority occurred later in time than the message having higher priority.

The operations 700 can also optionally comprise determining whether or not to resize a particular message area, in step 714. For example, the module 118 (FIG. 1) may determine to increase or decrease the size of the message display area, such as display area 204, depending on the number of messages received in the system. If the operations 700 comprise determining to resize the message area, the message area can be dynamically resized, in step 716. For example, the message display area dynamically increased in size from two lines to three lines when a message count increased from two messages to three messages, as shown from FIG. 2 (204) to FIG. 3 (302). This message area dynamic resizing may provide a visual indicator to a user that a new message has been presented.

In some implementations, messages may invoke more than one display area. For example, when an extremely high priority message is received, the system may display a modal dialog box in addition to the message displayed in the message area. In step 718, the operations 700 may optionally comprise determining whether or not to provide an additional modal dialog box to the user of the system. If the operations 700 comprise determining to provide the modal dialog box, the modal dialog box is displayed, in step 720.

In some implementations, some messages may include a navigation link to provide further information about a system event. The navigation link may be included with the message, or optionally included in a modal dialog box associated with the message. If the operations 700 comprise determining to include a navigation link in the message display, the link may be included in step 724. Some, all, or none of the optional display configurations may be selected, and regardless of the subset selected, the operations 700 may display the system message in the selected display area, in step 726.

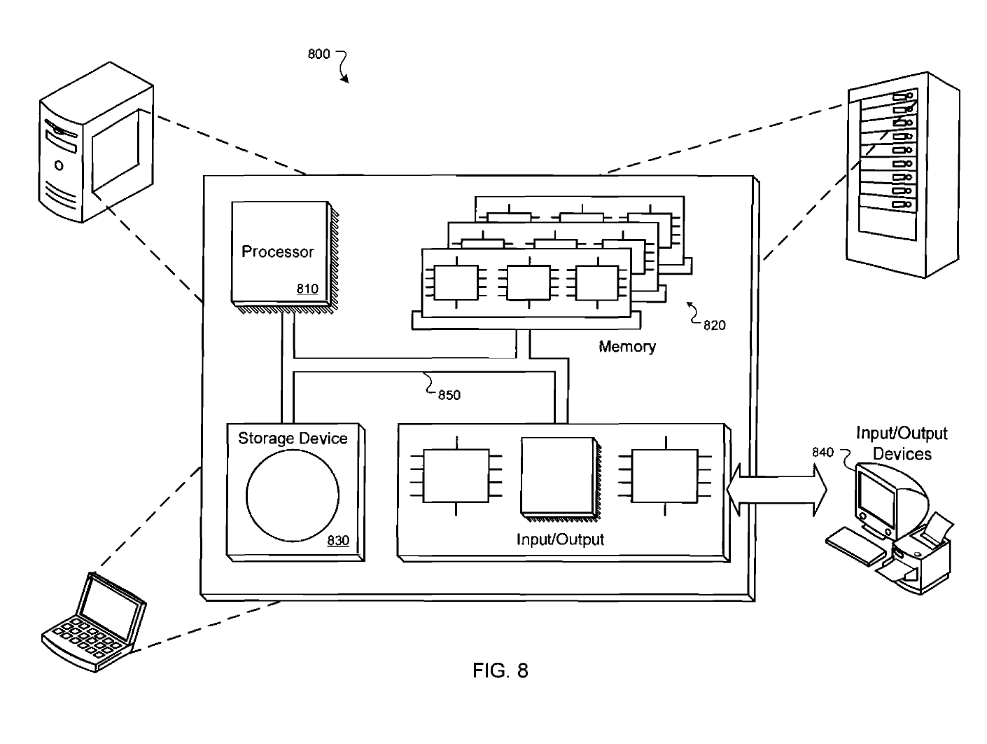

FIG. 8 is a schematic diagram of a generic computer system 800. The system 800 can be used for the operations described in association with any of the computer-implement methods described previously, according to one implementation. The system 800 includes a processor 810, a memory 820, a storage device 830, and an input/output device 840. Each of the components 810, 820, 830, and 840 are interconnected using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 may be a floppy disk device, a hard disk device, an optical disk device, or a tape device.

The input/output device 840 provides input/output operations for the system 800. In one implementation, the input/output device 840 includes a keyboard and/or pointing device. In another implementation, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method of handling events in an enterprise resource computing system, the method comprising:
receiving an indication that an event has occurred in an enterprise resource computing system, the event associated with an application of the enterprise resource computing system;
assigning, after receiving the indication, one of several priority classifications to the event, wherein each of the priority classifications corresponds to a distinct level of significance to a user of the enterprise resource computing system;
generating a system message to inform the user of the event, the system message including an indicator of the priority classification;
selecting one of a plurality of message display areas in a graphical user interface of the enterprise resource computing system for displaying the system message, each of the message display areas having a predefined location in the graphical user interface, wherein the selection of the message display area is based on the priority classification; and
displaying the system message in the selected message display area.

2. The method of claim 1, wherein the selected message display area is capable of displaying a plurality of messages.

3. The method of claim 2, further comprising displaying a plurality of messages in the selected message display area according to priority classification.

4. The method of claim 3, wherein a message having a lower priority is displayed in a less prominent position in the selected message display area than a message having a higher priority, even though the event associated with the lower priority message occurred later in time than the event associated with the higher priority message.

5. The method of claim 2, further comprising dynamically resizing the selected message display area when a new message is displayed.

6. The method of claim 2, wherein the message display area further comprises a scrollbar that can be navigated by the user to display additional messages.

7. The method of claim 1, further comprising displaying a separate work area associated with the application of the enterprise resource computing system on the display of the enterprise resource computing system, and wherein the event occurs because of an action associated with the separate work area.

8. The method of claim 1, wherein the event is associated with an application of the enterprise resource computing system that does not have any work areas displayed on the display of the enterprise resource computing system.

9. The method of claim 1, wherein a plurality of message display areas are concurrently displayed on the display device of the enterprise resource computing system, and wherein each of the plurality of displayed message areas includes a displayed message having a different priority classification.

10. The method of claim 1, further comprising displaying a modal window that includes information relating to the system message.

11. The method of claim 10, further comprising receiving user input associated with the modal window, and triggering an event that can be used by an application to start an action.

12. The method of claim 11, wherein the modal window includes a hyperlink, and wherein the user input is a selection of the hyperlink.

13. The method of claim 11, further comprising displaying, in response to the selection of the hyperlink, a field having focus established thereon and capable of receiving user input.

14. A computer program product tangibly embodied in an information carrier and comprising instructions that when executed by a processor perform a method for handling events in an enterprise resource computing system, the method comprising:
receive an indication that an event has occurred in an enterprise resource computing system, the event associated with an application of the enterprise resource computing system;
assign, after receiving the indication, one of several priority classifications to the event, wherein each of the priority classifications corresponds to a distinct level of significance to a user of the enterprise resource computing system;
generate a system message to inform the user of the event, the system message including an indicator of the priority classification;
select one of a plurality of message display areas in a graphical user interface of the enterprise resource computing system for displaying the system message, each of the message display areas having a predefined location in the graphical user interface, wherein the selection of the message display area is based on the priority classification; and
display the system message in the selected message display area.

15. The computer program product of claim 14, wherein the selected message display area is capable of displaying a plurality of messages, and further comprising instructions that when executed display a plurality of messages in the selected message display area according to priority classification.

16. The computer program product of claim 15, wherein a message having a lower priority is displayed in a less prominent position in the selected message display area than a message having a higher priority, even though the event associated with the lower priority message occurred later in time than the event associated with the higher priority message.

17. The computer program product of claim 15, further comprising instructions that when executed dynamically resize the selected message display area when a new message is displayed.

18. The computer program product of claim 14, further comprising instructions that when executed display a separate work area associated with the application of the enterprise resource computing system on the display of the enterprise resource computing system, and wherein the event occurs because of an action associated with the separate work area.

19. The computer program product of claim 14, wherein the event is associated with an application of the enterprise resource computing system that does not have any work areas displayed on the display of the enterprise resource computing system.

20. The computer program product of claim 14, wherein a plurality of message display areas are concurrently displayed on the display device of the enterprise resource computing system, and wherein each of the plurality of displayed message areas includes a displayed message having a different priority classification.

21. The computer program product of claim 14, further comprising instructions that when executed display a modal window that includes information relating to the system message, receive user input associated with the modal window, and trigger an event that can be used by an application to start an action.

22. The computer program product of claim 21, wherein the modal window includes a hyperlink and the user input is a selection of the hyperlink, and further comprising instructions that when executed display, in response to the selection of the hyperlink, a field having focus established thereon and capable of receiving user input.

23. A computer program product tangibly embodied in an information carrier, the computer program product including instructions that, when executed, generate on a display device a graphical user interface for presenting system messages, the graphical user interface comprising:
a plurality of message display areas having a predefined location in the graphical user interface in which system messages can be displayed, each system message associated with a system event having a determined priority classification, wherein each of the system messages includes an indicator of the priority classification of the associated event, and wherein display of each of the system messages in one of the plurality of message display areas is dependent upon the associated priority classification.
